(19) United States
(12) Patent Application Publication
(10) Pub. No.: US 2025/0014133 A1
(43) Pub. Date: Jan. 9, 2025

(54) SYSTEM AND METHOD FOR IDENTIFYING COLLABORATIONS AND STRUCTURE IN AN ORGANIZATION BASED ON COMMUNICATIONS

(71) Applicants: Apoorv Srivastava, Franklin Park, NJ (US); Patrick O'Neal Nunally, San Diego, CA (US); Antonio Daggett, San Diego, CA (US); Ali Taheri, Chula Vista, CA (US); Michael G Martin, San Diego, CA (US); Ty Smith, Coronado, CA (US)

(72) Inventors: Apoorv Srivastava, Franklin Park, NJ (US); Patrick O'Neal Nunally, San Diego, CA (US); Antonio Daggett, San Diego, CA (US); Ali Taheri, Chula Vista, CA (US); Michael G Martin, San Diego, CA (US); Ty Smith, Coronado, CA (US)

(73) Assignee: Commsafe AI, San Diego, CA (US)

(21) Appl. No.: 17/902,773

(22) Filed: Sep. 2, 2022

Related U.S. Application Data
(60) Provisional application No. 63/360,097, filed on Sep. 2, 2021.

(51) Int. Cl. G06Q 50/26

(52) U.S. Cl. CPC G06Q 50/265

(57) ABSTRACT

The disclosed embodiments relate to systems, methods, and apparatus for analyzing and classifying communications by or between one or more users. More particularly, the present disclosure relates to inferring or drawing conclusions about one or more communications derived from content metrics in near actual time or batched.

### BACKGROUND OF THE INVENTION

### Field of the Invention

The present disclosure relates generally to systems and methods of analyzing and classifying communications sent over a communications network by or between one or more users. More particularly, the present disclosure relates to characterization and classification of communication in the data traffic flows over a network in real-time, near real-time, or batched.

### Description of the Related Art

Current state of the art technology can perform sentiment analysis and classification of any communication texts; however, few software solutions track the change in sentiment over time and convert it into an actionable item. In one illustrative example, as instances of unprovoked and unexpected violence and conflict in both the workplace and public places rises, the general population is worried and on edge. Workplaces, as well as hospitals and other places of employment, struggle to provide meaningful training, and employees are at a loss as to how to protect themselves in the event of a serious workplace violence attack.

Direct consequences of major world events, for example, the recent COVID-19 pandemic can result in an increase in people working more and more from locations remote from the office, especially in their homes. This brings about an increase in the use of electronic communications to communicate with each other, for example direct messaging, social networking, and video conferencing.

In most cases of workplace violence, bullying, harassment or discrimination, the dangerous behavior begins with toxic communication. Hence, if we can identify toxic communication early on, we can prevent many instances of violence, harassment, discrimination, or even self-harm.

### BRIEF DESCRIPTION OF THE DRAWINGS

While the appended claims set forth the features of the present techniques with particularity, these techniques, together with their objects and advantages, may be best understood from the following detailed description taken in conjunction with the accompanying drawings of which:

FIG. 1 illustrates an overview of an electronic communication platform in an organization.

FIG. 2 illustrates an exemplary method of this system described in FIG. 1.

FIG. 3 illustrates a flow of the method carried out by the AI architecture component of the platform.

FIG. 4 illustrates an example AI architecture component of the platform.

FIG. 5 illustrates an example inference component of the AI model.

FIG. 5 illustrates the updating component of the learning model.

FIG. 6 illustrates n-tuple characteristics and charting of the relationship between users.

FIG. 7 shows snapshots of the company communication graphs captured over time.

FIG. 8a illustrates and embodiment of the company dashboard.

FIG. 8b illustrates and embodiment of a report querying validity of a flagged message.

FIG. 9 is an example notification to a mobile device.

### DETAILED DESCRIPTION OF EXEMPLARY EMBODIMENTS

Turning to the drawings, wherein like reference numerals refer to like elements, techniques of the present disclosure are illustrated as being implemented in a suitable environment. The following description is based on embodiments of the claims and should not be taken as limiting the claims about alternative embodiments that are not explicitly described herein.

The phrases “connected to,” “coupled to” and “in communication with” refer to any form of interaction between two or more entities, including mechanical, electrical, magnetic, electromagnetic, fluid, and thermal interaction. Two components may be functionally coupled to each other even though they are not in direct contact with each other. The term “abutting” refers to items that are in direct physical contact with each other, although the items may not necessarily be attached together.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

A better understanding of the various features of the disclosure can be gleaned from the following description read in conjunction with the accompanying drawings in which like reference characters refer to like elements, where reasonably applicable. While the disclosure may be susceptible to various modifications and alternative constructions, certain illustrative features are shown in the drawings and are described in detail below. It will be understood, however, that there is no intention to limit the disclosure to the specific embodiments disclosed, but to the contrary, the intention is to cover all modifications, alternative constructions, combinations, and equivalents falling within the spirit and scope of the disclosure.

Furthermore, it will be appreciated that unless a term is expressly defined in this disclosure to possess a described meaning, there is no intent to limit the meaning of such term, either expressly or indirectly, beyond its plain or ordinary meaning.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

Embodiments of this disclosure relate to a system for classifying certain text in a communication or in more than one communication over time. Discussion of one or more embodiments of a method and system according to this disclosure will now be discussed below in connection with one or more figures.

In one embodiment, cloud-based software analyzes employee communication and uses predictive algorithms to identify, classify, and flag certain communications, for example, toxic communication. This helps companies disrupt emerging threats of harassment, aggression, Title IX offenses, discrimination, conflict, and threats, which cost US workplaces in both dollars and productivity.

In one embodiment, a focus man be on safety for people in public places, especially for people in the workplace, which is a concern growing larger every day. This is a natural extension of the growing need for greater understanding of effecting better security and law enforcement by better understanding human behavior. The embodiments herein provide methods for effecting greater diversity, inclusion, mutual respect of human beings taking better care of each other, and of organizations reaching their goals while upholding important values that they cherish.

Embodiments include methods for preventing conflict and violence in the workplace, while promoting diversity and inclusion. The system disclosed utilizes an AI tool to provide embodiments that help companies fight against bullying, harassment, aggression, Title IX offenses and other toxic communications.

Using Machine Learning, AI, & Natural Language Processing, embodiments measure thousands of daily communications (and more) data points across business applications or communication devices, methods, and software. The novel scoring system described herein generates actionable analytics that measure productivity and create immediate opportunities for process improvement, while respecting employee privacy.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

In one embodiment, the system gathers a collection of user behaviors to establish a baseline behavior. The system will be able to identify anomaly behavior. The system will be able to predict behavior based on anomalies from the baseline behavior by the same user. The system can generate one or more factors (1 . . . n factors) that can be stored and can be viewed in a finite ordered list or sequence of elements, also referred by those skilled in the art, as an n-tuple where n is a non-negative integer representing one or more measurable characteristics or behaviors indicative of a behavior or other criteria for which a user wants to measure. In the system, this measurement or classification can be referred to as a sentiment or sentiment score. In this context, the sentiment can be used to convey the overall feeling or indication about the communication whether that be as toxic, dangerous, detached, etc, as well as conveying when overall feeling is engaged, baseline, neutral, etc. Over time if desired, n-tuple data is captured and can show a progression of sentiment and changes or stability to sentiment, over a period of time. Once collected, the system used the data to draw a conclusion which is objective and quantifiable.

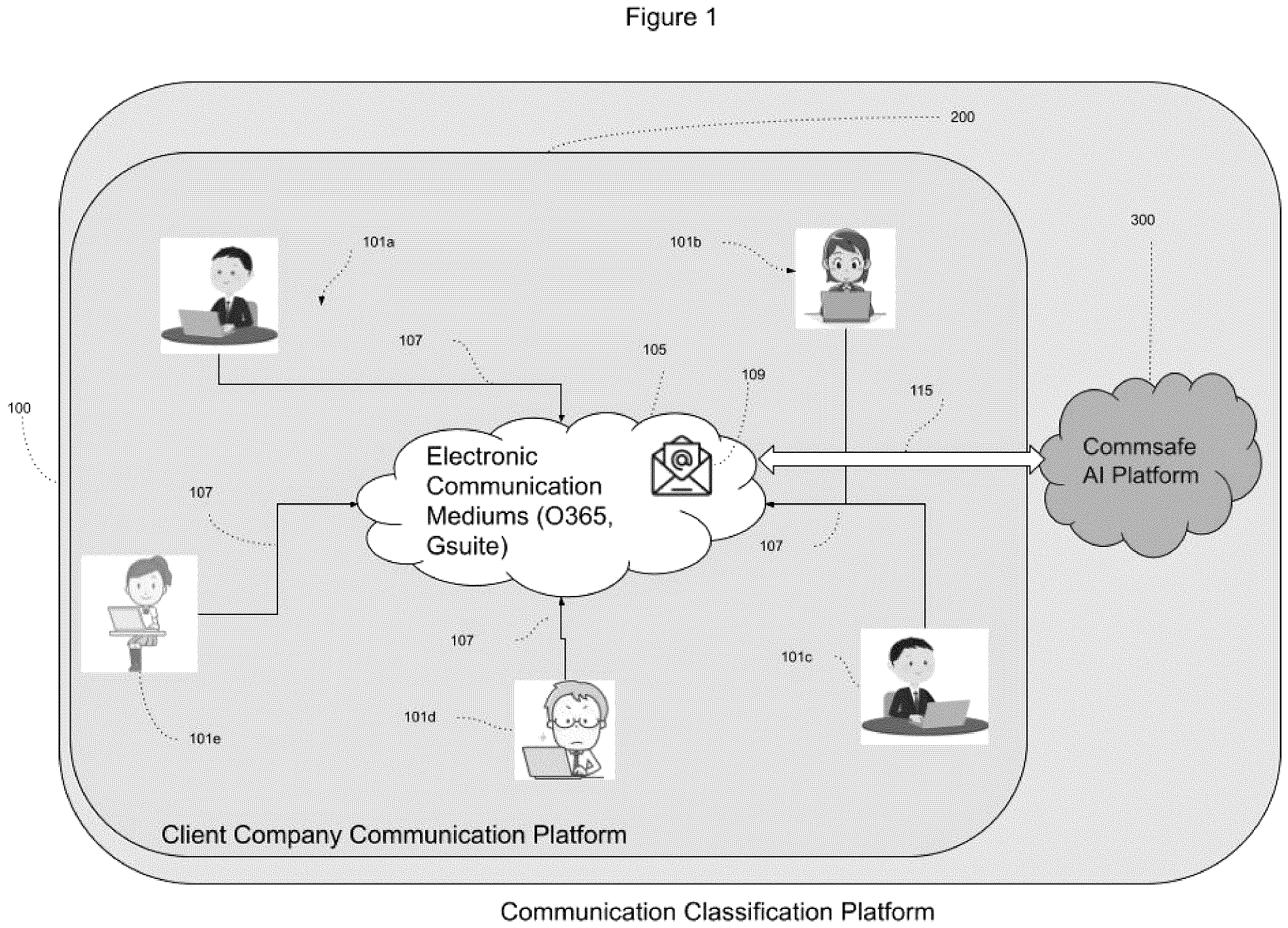

FIG. 1 illustrates an overview of a communications classification system platform 100. The communications platform 100 can comprise an electronic communication system 201 and an AI system 300. The platform 100 can also comprise users, for example, 101a-101e, a communications network 105, and a means 107 of sending communications 109, 111, 112, for example electronic messages, emails, chat, or electronic bulletin board postings. For simplicity, a user or group of users can be referred to hereinafter as simply 101. Any user 101 can communicate with one or more other users 101 utilizing the communication network. The system 100 as described herein can capture and analyze any communication so long as it is relayed through the electronic communication network 105 medium.

The platform 100 enables an electronic communication system 201 and an AI system 300 for use in an organization where users, for example, 101a-101e, associated with the organization can communicate with each other within the organization. Users can also communication with one or more users outside the organization. The users can send messages to one or many users or may also send other messages, for example, a post on an electronic bulletin board message for one or more users.

As described herein, users 101 can be the sender of a message or the receiver of the message 109. The user can send messages that can comprise a text message, an email, a chat message, or any other communication that is capable of being annotated and identifiable as belonging to a targeted grouping of said messages.

The communications network 105 can comprise a company networking system or other messaging means. The communications network 105 can be any communications system or pathway that facilitates or enables communications between users.

The means of sending the communication 107 can comprise any means for communicating the message between two or more users 101. For example, the means of communication can comprise an email server or email system, a chat program, or other like systems.

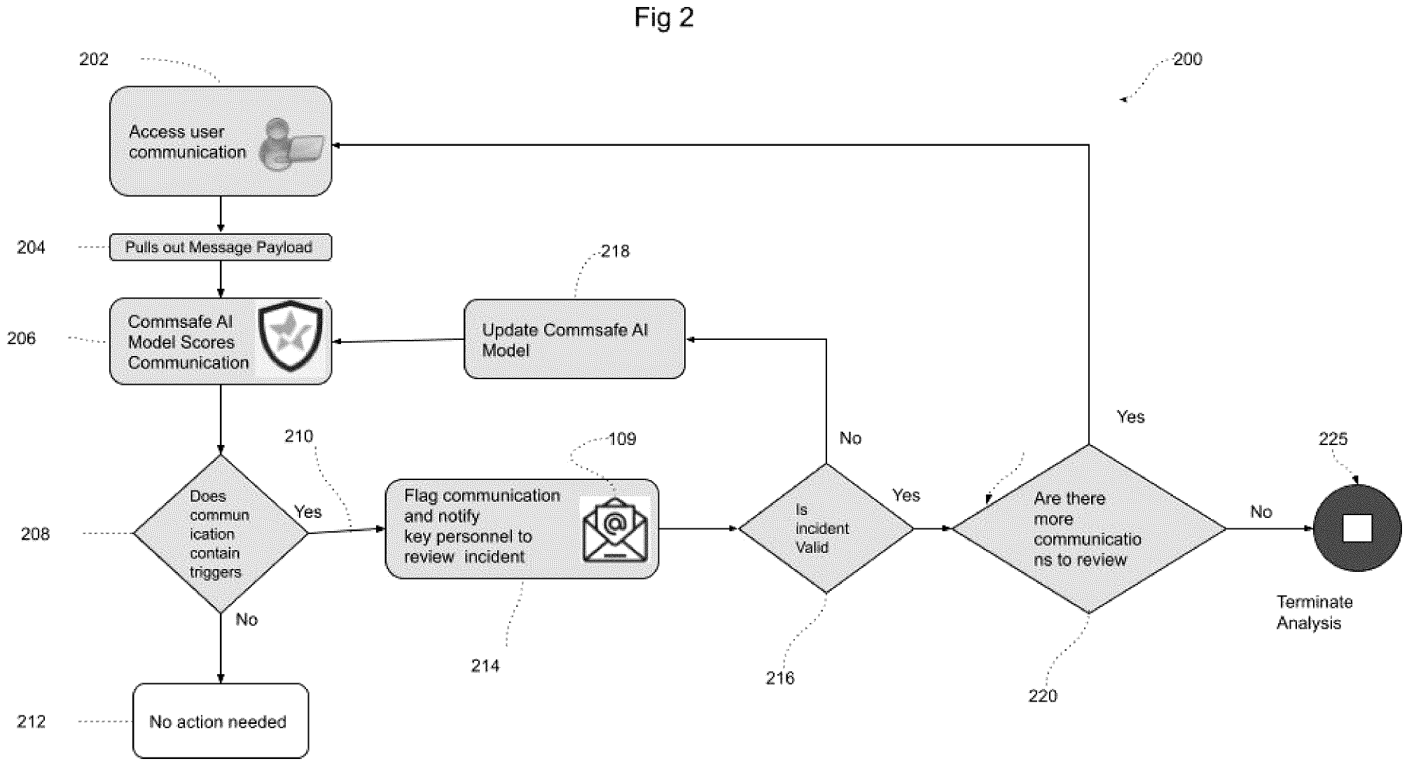

FIG. 2 illustrates an overview of a method 200 that can be used in platform 100. From a general perspective, the system commences its work when employee or employees 101 communicate with other employees or user within a group, for example, a company. The users can also be outside of a company. At a high level, as the employee(s) communicate, the system scans communications on the customer's servers and then compares the content with configured protocols and proprietary data. The system can access the communications either in real-time or over a period of specified time, or on a schedule.

One task that the AI system performs is classifying communications. At entry point 202 the user communication is accessed, and a copy of the message is sent to the AI scoring system. The information in the copy that is sent to the AI system at 204 is a specific subset of information, the payload, which is germane to the analysis done by the AI system. At 206 the AI system scores the communication with a sentiment or numeric score. The sentiment score is evaluated at 208 to determine if the communication contains one or more triggers that would cause it to be flagged for a certain reason. If the communication does not contain any triggers, the analysis terminates at 212. If the determination at 208 indicates that the communication contains one or more triggers, the system advances 210, and the communication 109 is flagged as such 214, and a specified contact is notified. When the specified contact reviews the communication, the flagged status is determined to be valid or invalid 216. If the communication score is valid the system looks for more communications to score at 220. If there are no more communications to evaluate, the system terminates the analysis at 225 until ready to process a new communication message. At 212, if the score is determined to be invalid, the communication and the information about the incorrect score is sent to the AI scoring model component so the model can be updated 218. Once updated, the communication can enter the system flow again at 204.

In one embodiment, if the identified score was valid, a specified group, for example HR/Legal, can determine the severity and appropriate action. The system can consider and indicate whether the issue is of a certain standard, for example, Level 1 or Level 2. In one case, if Level 1, then the responsible entity, for example HR or Legal provides Guidance and or training to team members. If a Level 1 communication is flagged and guidance or training is provided, then employees who receive guidance early can have improved outcomes and communicate better. If level 2, the Resolution team can be advised and can plan accordingly.

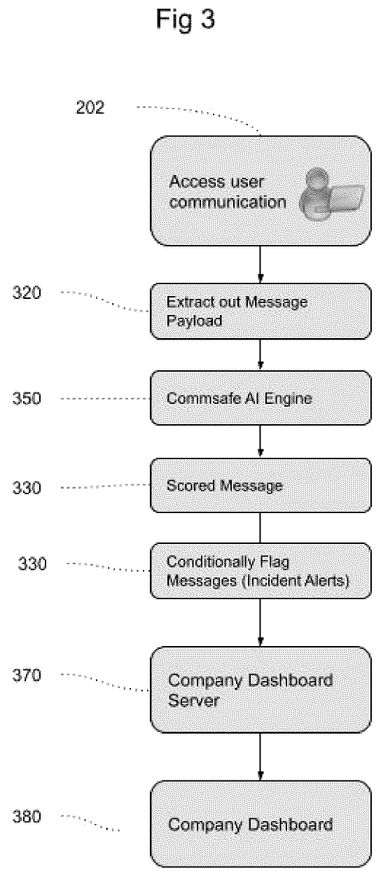

FIG. 3 is a further detailed example of an AI communication system 400 and how the scoring can be determined against the message and then assigned a sentiment score according to the system of FIG. 2. Initially a communication is sent by a user 101 via the client company communication platform 201, and a copy is forwarded from the communications network 105 to the AI platform 400 for evaluation. Once received the payload of the message extracted 310 and is prepared for analysis by the scoring engine. When received 320 into the scoring engine, the text of the message is compared against the criteria data in the model and once complete, the AI model assigns 330 a score to the communication. At 330, the system determines whether or not the communication contents contain messaging that should activate a trigger. If not, nothing is done. If 340 the message is flagged as having triggers, the message is sent for follow up and annotated with information indicative of the sentiment identified. The system then, at 370, 380, communicates the flagged incident to key personnel for review.

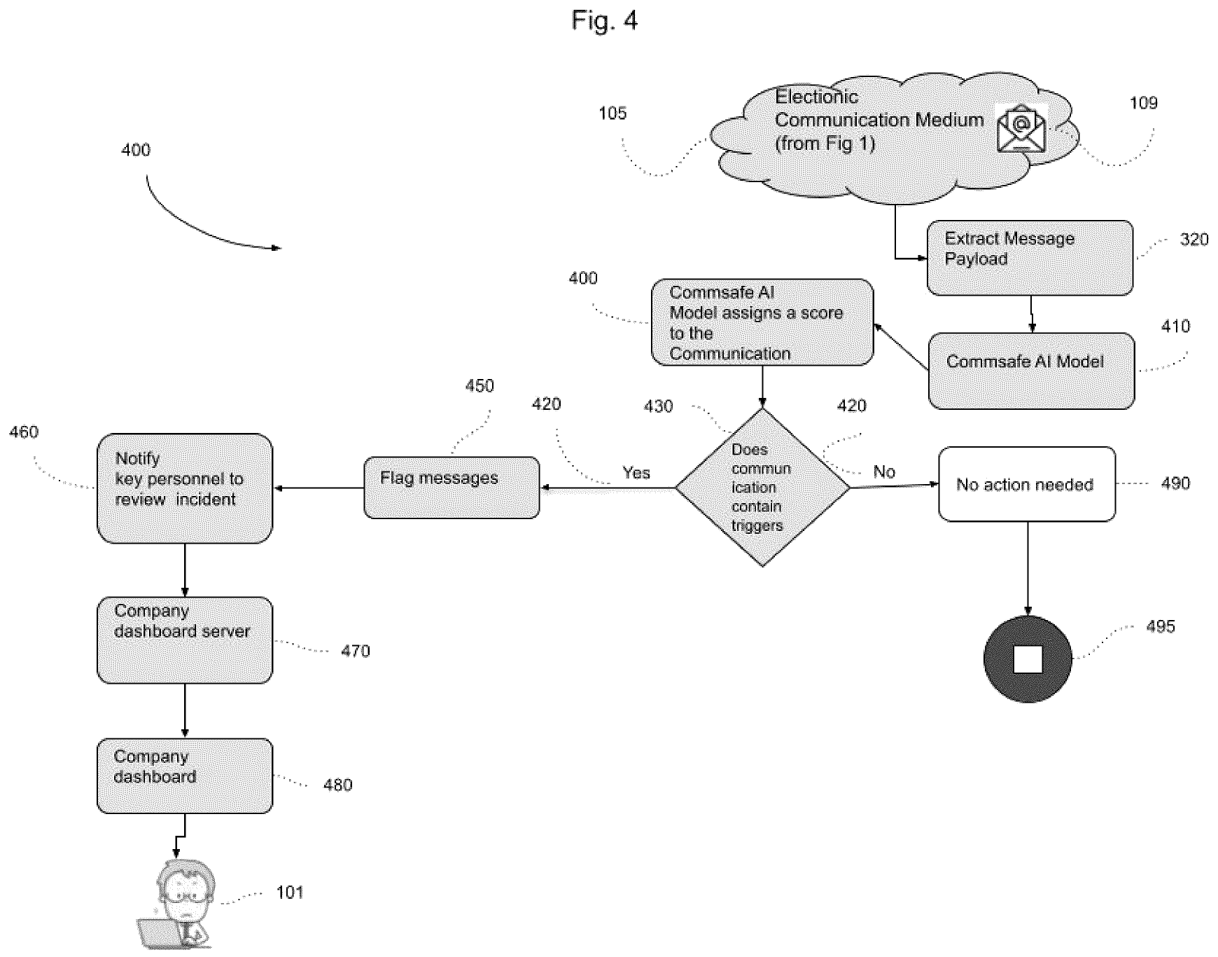

FIG. 4 illustrates an example AI Architecture 400 as described herein. An example architecture 400 for system 100 is described herein. Within the architecture 400, the users 101 receive and send messages 109, for example emails. In another embodiment, the messages are chat messages, such as MS Teams chat messages. In one embodiment, the messages 109 are stored in a cloud, for example, a Microsoft Office 365 cloud server 105 of the communications system 201. A copy of the message 109 is sent to the Learning Model Engine 450 which comprises a notification endpoint 420, message extractor 430, the message payload 425, an AI 460, a scoring component 440 yielding a score 442 for the message used in determining the message sentiment 455 (not shown), and a message flagging operation 470. The architecture 400 also comprises a company dashboard server 801 and a company dashboard client view 802.

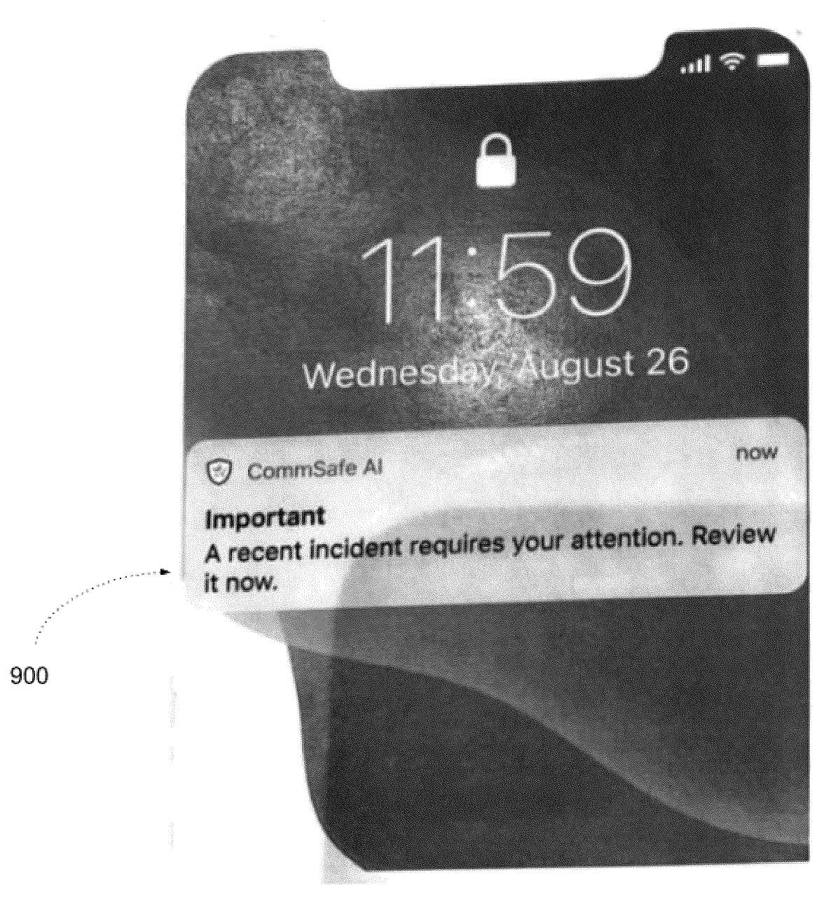

In one embodiment, the user 101 sends a message 109, and the Microsoft Outlook 365 server 105 sends a notification 420 or an alert that an email 109 has been sent. The notification 420 can be sent to an administrator or other designated recipient The system 100 requests a copy of the message 109 and sends it to the Learning Model Engine 450. At 430 the message payload 425 of the message 109 is extracted. The system then sends the extracted portion 425 to the AI module 460 which is configured to score the extracted text 425. The score 442 is indicative of the level of some factor that the system is measuring. The score 442 is combined with the original message 430 to form 440 the scored message. In one embodiment, the system is assigning a score associated with the toxicity of the email. In other embodiments, the score is indicative of a level of a defined measurement that the system administrator or user wishes to measure. If the score is above a certain threshold, then the message, e.g. email 109, is deemed to comprise a flaggable level 470 of triggers. In one example, the flagged message contains toxic text content. Thus, in the instant example, if the email is found to be toxic, the system generates an alert at 470. The alerts are entered into a database and stored on the company dashboard server 801. The alerts are also displayed on the company dashboard client view 802. In an embodiment, a Web app can display the alert on the user's 811 electronic devices, for example as shown in FIG. 9.

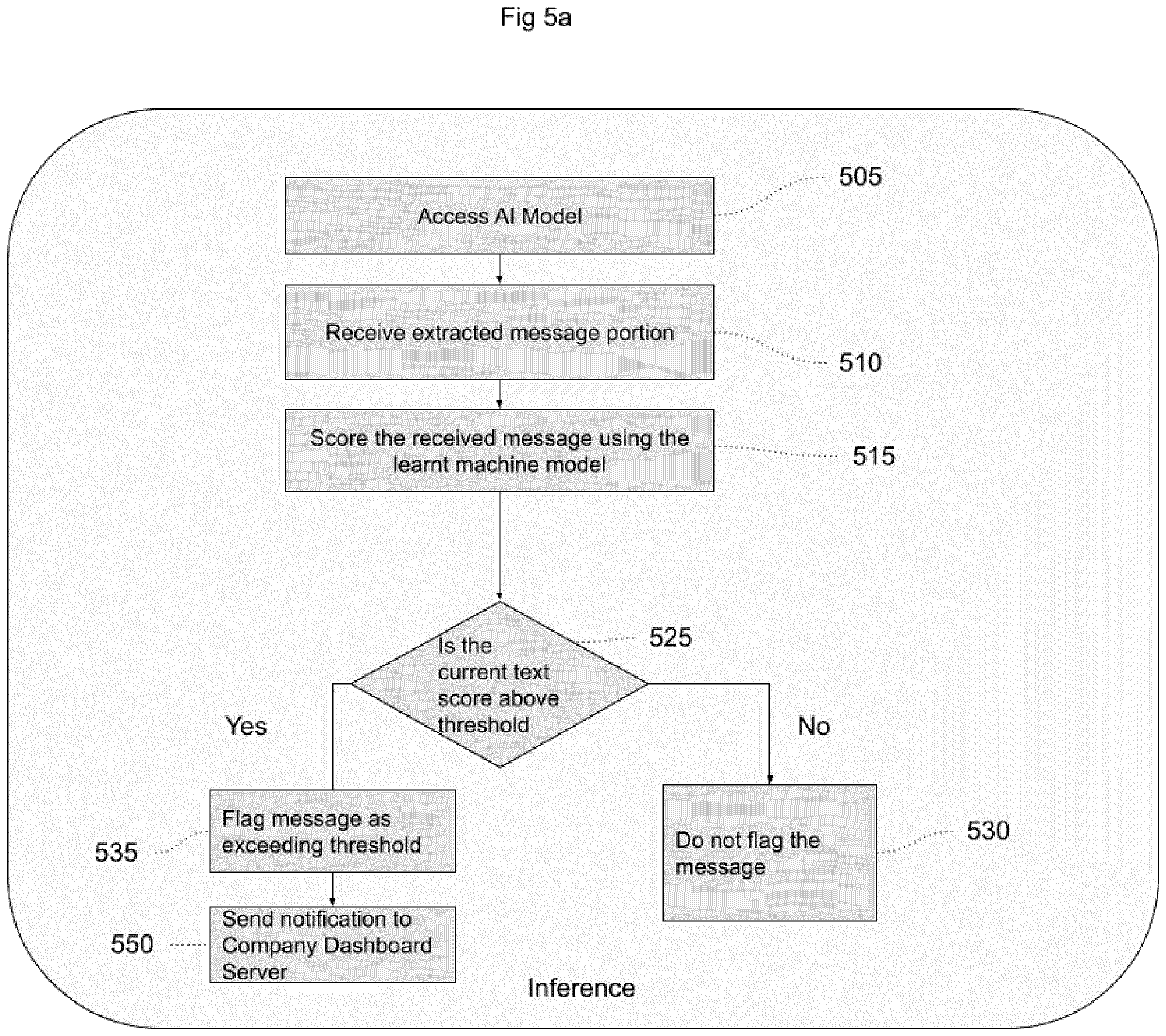

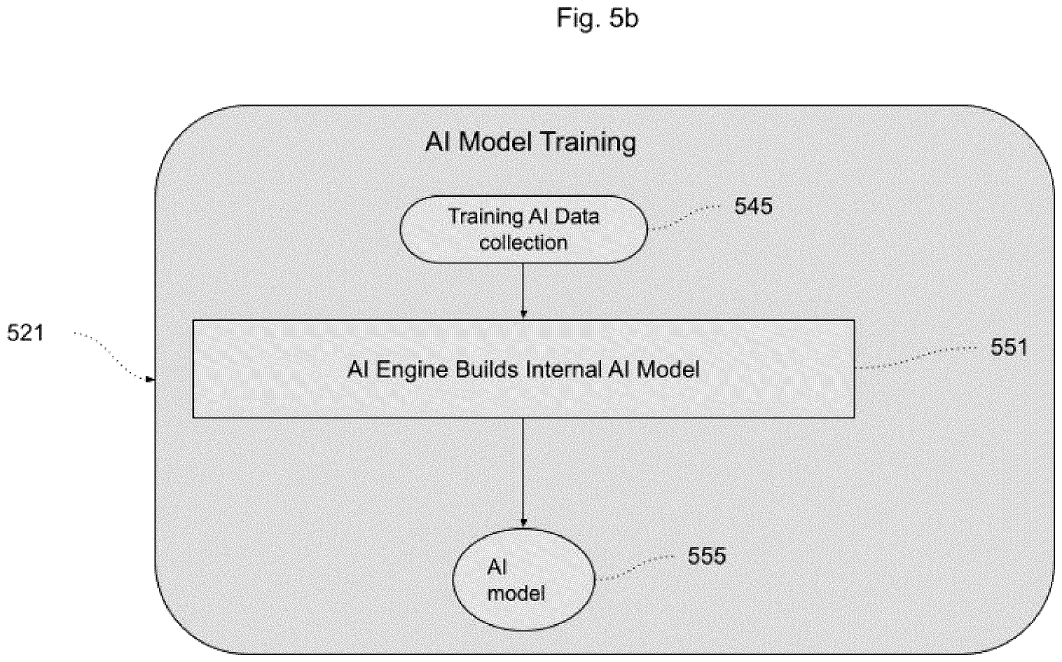

FIG. 5a illustrates a component of AI comprising the inference where, at 505, the AI system is accessed, and at 510, a new message sample, e.g. text, is provided to the AI. At 515, the system compares the extracted message text against the stored tagged text. Next, at 520, the system annotates the current text message to be scored or not, according to the designated criteria. Once scored, the system will consider at 525 whether or not the sought measurement threshold is achieved, and, if not, the message is flagged as not of concern 530 and no further review is necessary. If the message score is above a certain threshold, then the message is marked as such 535. For example, the message may be designated as toxic. From here the message or associated notifications are sent 550 to the company dashboard.

FIG. 5b describes further the Learning Model Engine. The AI continually learns and updates the training data 545 defined therein. The updates to the AI are accomplished by adding new annotated text samples to the training set and then simply retraining the system 551 to detect the new toxic messages and tag them such.

The protocols define that which the system is measuring and scoring. Training and updating the Learning Model Engine comprises two steps. Initially, the AI baseline stored data can be populated with a base set of pre-scored, or pre-tagged, data. This data can either generated by the owner/user, or in another embodiment, it can be provided in bulk by purchase or other means. Over time, the data collection by which the messages are scored needs to be updated with additional data and annotations. First, the system trains itself with the tagged data it receives and stores. The data is tagged in that it is annotated by the system to indicate whether it meets a pre-determined criterion, or not. The tagged data comprised data indicative of all levels of scoring, including data that would not be flagged as unusual for any reason. In one embodiment, the data comprises many thousands of text samples with the associated tag indicative of a factor that contribute to a predictive score of each sample being measured. The number of samples can scale exponentially. The AI is then configured to build its own model that differentiates “normal” sample from the “abnormal” text. In this context abnormal text is used to refer to text that would be flagged as outside the baseline or normal threshold. The learning is stored as the machine-model.

The data can be updated on a schedule or in real-time. In one embodiment, the data is updated monthly. The data that provides the update is tagged, and the system then learns from the updates. In one example, the updating is provided by the text from a message that would then cause a flag to indicate that message meeting criteria that is not acceptable. Training and updating the AI comprises two steps.

The system 100 is configured such that the AI system can comprised of one or more AI components that return a value associated with that which they measure. This measurement category can be expressed as a tuple, for example a given AI can be expressed as evaluating 1 . . . n tuples where each tuple is an AI-scored indicator. In one embodiment, the system 100 is configured to learn and capture toxic emails and to return the results for the single tuple to a results dashboard. In another embodiment, the system 100 comprises three (3) different AI components that are configured to measure a sentiment in the workplace. In such an example, the three AI components examine message data for toxic text, frequency, and length of message. The three tuples can be communicated to the end user in a variety of ways, for instance in graph form, list form, and other ways that show the relationship that is being measured.

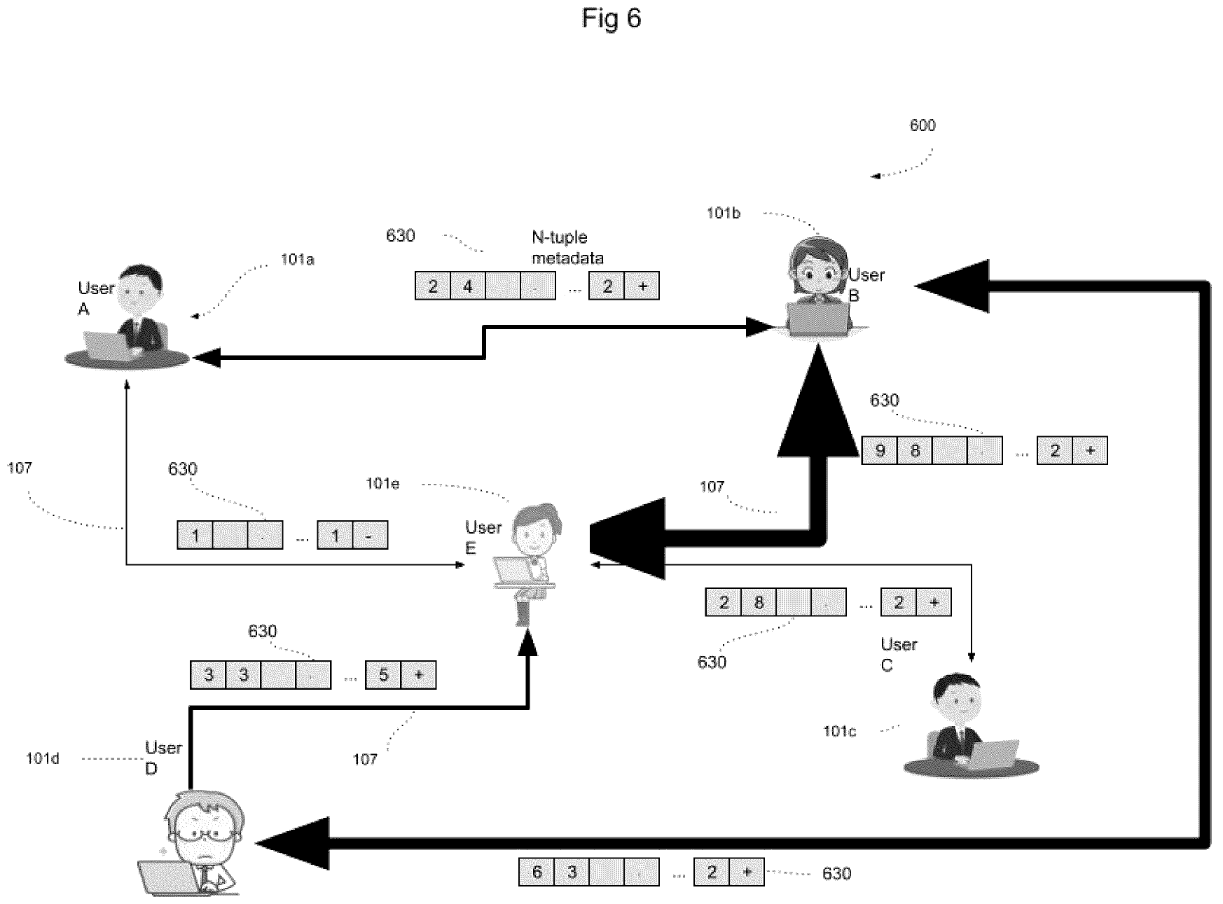

FIG. 6 illustrates a visual embodiment of the flagged data. For example, a graph illustrating characteristics indicative of the communication between the users (within and outside the organization), called a communication graph. In the communication graph 600, each communication between users 101 a-e, for example, is represented by an edge 610 that is tagged with an n-tuple that represents something that is being measured or evaluated or classified by the system. In one embodiment, this presents the quality or quantity, or another attribute related to the communications; for example some characteristics tracked can comprise the sentiment of the communication, length of the communication, average number of communications in a day, key words used in the communication, ratio of negative to positive communication. In the shown example, the n-tuple indicates 1-n measurements that are being sought. Each of 610a, 610b, 610c 610d, and those associated with other edges and not shown in FIG. 6 display for the end user the value of the criteria being measured as between endpoints. In the example shown in FIG. 6, the graph shows the returned value for n-tuples as between two or more users. This can be used to show a change in one or several things, for example, a change in the amount of communication between two users and can further indicate sentiment between two employees, or amongst employees assigned to a project.

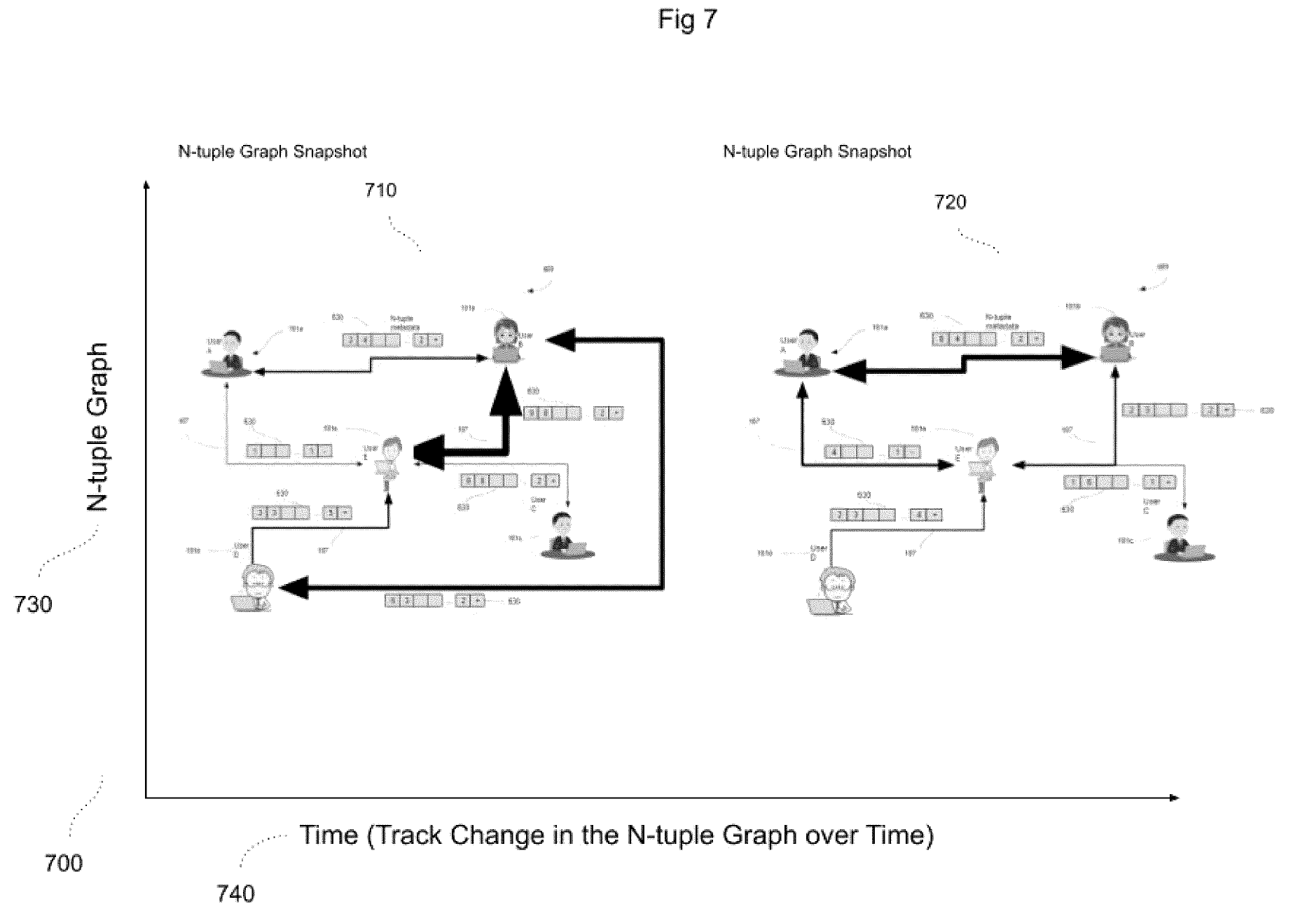

FIG. 7 illustrates another example of the reporting of the results of the system 100. In one embodiment, the reporting can show snapshots of the company communication graphs captured over time. In much the same way as shown in FIG. 6, these graphs, collectively 700, show how key measurements change over time. Thus, for example, a user might see that the 1st, 3rd, 7th, and 11th, tuples have indicated values that change over time in a range that indicate a condition that should be flagged.

The current figure illustrates examples of n-tuple values and the relationship to the subsequent chart or analysis. For example, in an embodiment, the software analyzing the communication stores information gleaned from the communication. In an embodiment, the communication comprises electronic mail. The n-tuple may consist of n=6 data points. In an embodiment, these data points comprise the length of the email, presence of certain words, abusive language, or other factors.

The feature of the system to show relationships over time is one of the most innovative features of the system. In one novel embodiment, it has been shown that placement of certain words can be indicative of the nature of the news. For example, if profanity is used at a certain location in relation to the start of a message, it has been proven true that those messages comprise untrue or fake news stories purporting to be valid.

In other embodiments, the tuples, or metadata, can be used to indicate how many communications are being sent to a particular email address and whether those are outside of the company or organization. This can help detect corporate espionage and other crimes against the client/subscriber.

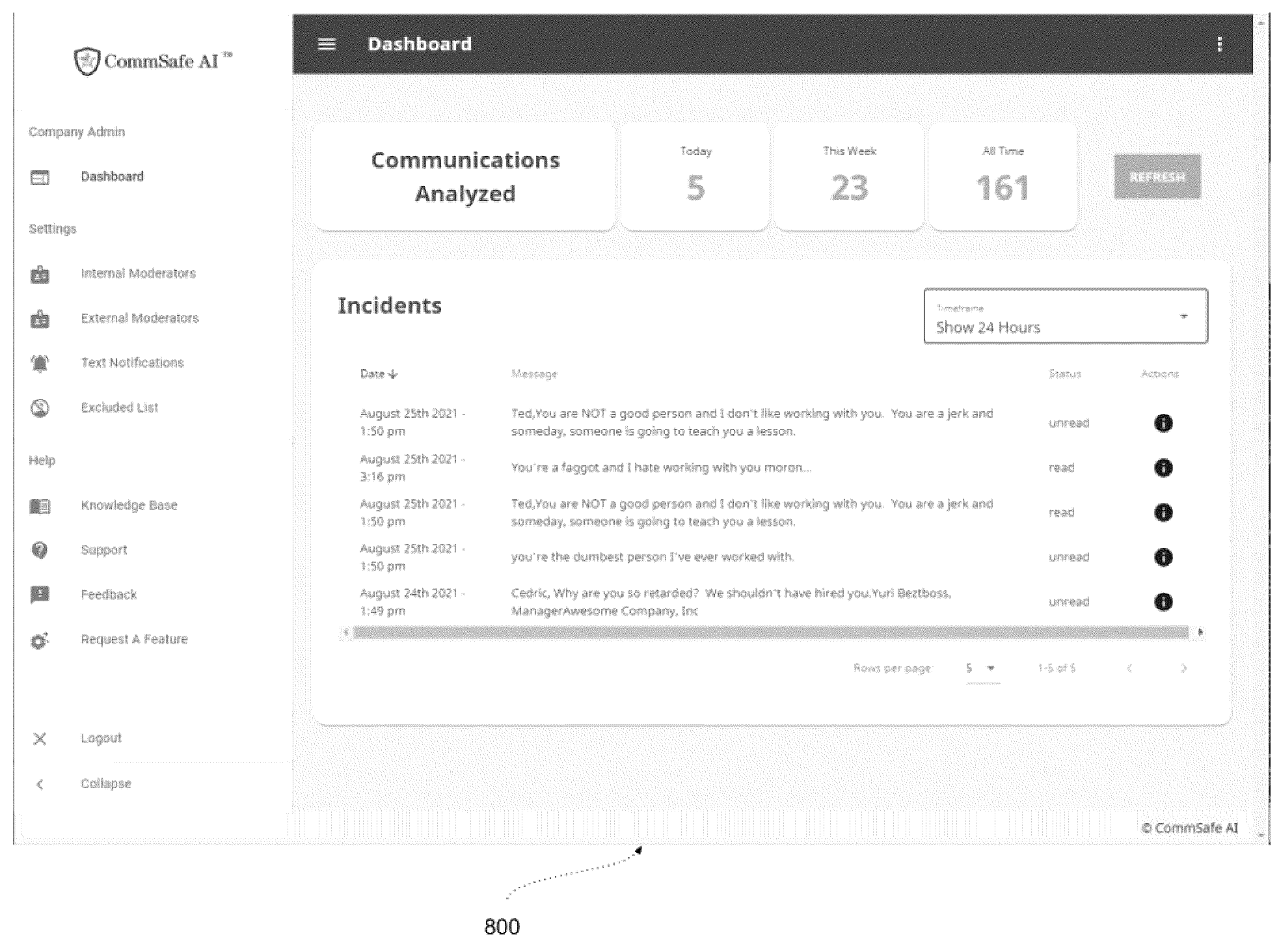

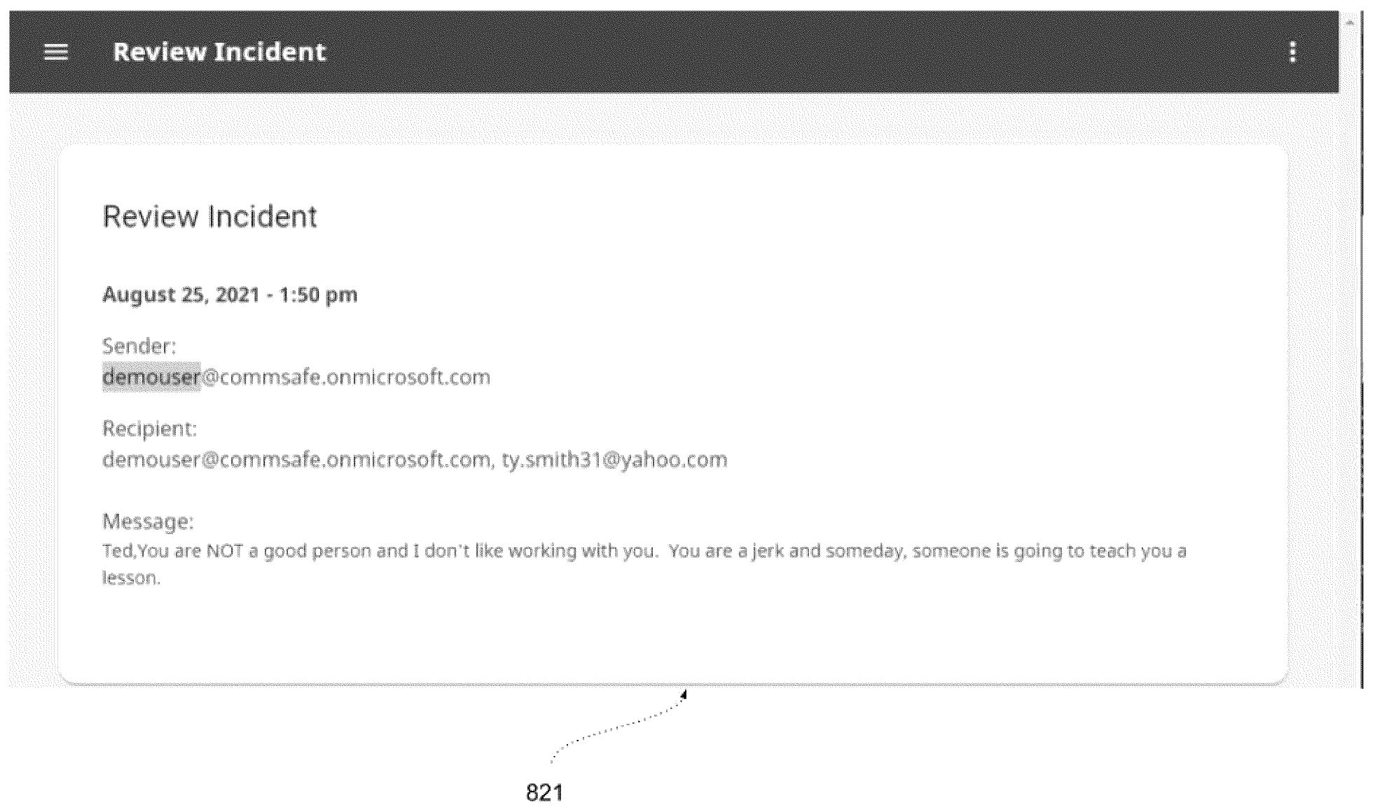

FIG. 8a and FIG. 8b illustrate two examples of how the system can relay results. FIG. 8 is a screenshot of an example incident report for viewing by an administrator or company designee. FIG. 8b is an example of an incident review that would be forwarded to an administrator for further review and validation of the flagged incident.

Alerts and other conclusory information can be displayed on a user dashboard and in alerts 900 that can be sent to a mobile device for example, as shown in FIG. 9. The use of these alerts used with the system described herein which predicts and identifies workplace violence and toxic communication in real-time, results in immediate intervention and a safe space for employees.

In sophisticated environments, the assimilated data can assist a company with many inefficiencies and safety issues. In some embodiments, the user can take the graph and other data and apply it and bring insight. For example, categorizing and flagging hierarchical communication, levels of communication and changes in communication tone, and changes in increases or decreases in communication for certain events can provide sophisticated insights into employee behaviors that would not otherwise be possible.

System 100 and associated methods can be used to identify one or more abnormal behaviors between users. One method includes intercepting and analyzing emails exchanged between identifiable users. The subject communication or email would be re-directed to the server and scanned for certain, for example, abnormal, criteria. The system then obtains behavior information from the flagged abnormal communication and inputs the behavior information of the abnormal communication into a database or other collection of information, for example n-tuples arrangement for storage. These criteria become a dynamic detection collection of factors that are constantly obtained and refined against one or more of the stored behaviors. In one embodiment, communication between User A and User B are diverted to the server and the communications over a period are gathered. Via the software, the supervisor, or receiving supervisor, can be notified of alarming behavior.

The systems and methods described herein can be used in many useful ways that are not achievable by human interpretation and analysis alone. According to the Bureau of Labor Statistics (BLS) 2015 National Census of Fatal Occupations Injuries, the problems caused by lack of recognition of employee behaviors are estimated to cost the US government alone in hundreds of billions of dollars. Workplace violence, bullying, sexual harassment, and other forms of discrimination result in a significant decrease in employee productivity and increased employee turnover. In some cases, employee turnover suffers for eighteen weeks or more, and employee turnover can rise as high as forty percent per evert. And, according to a study published by the US DOJ Workplace Violence Special Report, in cases where litigation ensued, the average jury award exceeds three million dollars.

The n-tuples can comprise any number of parameters including time-dependent parameters but may also comprise parameters such as: number of communications sent in a time frame, sentiment of the communication, subject of the communication, number of toxic communications sent in a time frame, length of the communications, word count of the communications, and others.

In an embodiment, the system can detect discriminatory behavior. In another embodiment, the system can detect abusive language. The system can detect when an employee in a position of power might be abusing their power or acting in a retaliatory manner. As the data is gathered and analyzed from a series of communications, the resulting n-tuples are applied against the user's profile to determine if abnormal behavior is suspected. The data can be gathered by the system on a schedule or triggered only by certain events. The identification of suspected issues can be sent or directed to another user to be independently verified.

In one embodiment, the system can produce a score that is representative of data that one or more surveys would produce. However, in this case, a survey would not have to be drafted or administered, and the results would not be skewed by any users being conscious of being scored. In this embodiment, a sentiment score is defined as being representative of a parameter in an n-tuple system. The sentiment score comprises and represents a proxy for surveys across a group, division, or an entire company. Referring to FIG. 6, taking the average of the sentiment across all edges, for example, 3 edges, of a communication graph within a group, division or company and thus obtaining an average sentiment score. This average sentiment score across time, such as is shown in FIG. 7 is an indicator of the changing sentiment in a group, division, or entire company etc., for example, and could be correlated back to certain decision, announcement, or policy decisions within each group, division, or company. The sentiment score or scores in this case act as a proxy for surveys across a group, division or the whole company.

In one embodiment, the system can examine the number and subject of communications being received by any individual, for example the node 1 in Fig. (X), to determine if that individual is a subject matter expert in a company. This can also be used to determine if the reporting structure in a company also reflects the communication in a company.

In yet another embodiment, the system can assist with identifying corporate espionage and security breaches. In this embodiment, one of the parameters in an n-tuple model would be defined as the recipient of the email or member on a cc-list. This parameter can be used to determine if an individual is sending emails to a personal email account with company confidential information.

In other embodiments, an AI engine can be developed to learn and identify certain behaviors. For example, to identify behavior that indicates that an employee will be leaving their employment. In another example, the opposite can be tracked, and the user can gather information useful to employee retention. In an embodiment, the system can compile a multi-dimensional chart. Changes in human behavior occur every minute. By reading company emails and analyzing for behavior, the system trains itself to learn to identify text that indicates discrimination, abusive language, and other behaviors. In other embodiments, the system can identify certain behaviors beyond reading texts and emails. For example, the charts as shown in FIGS. 6 and 7 can help identify retaliatory behavior. In one example, the system can show a pattern of gradually excluding a certain employee from group emails or more important project emails. In other embodiments, the system can identify other forms of exclusion. In other embodiments, the connectivity graph in a company can show this type of behavior in the communication between employees in a snapshot or over time.

Reference throughout this disclosure to “an embodiment” or “the embodiment” means that a particular feature, structure, or characteristic described in connection with that embodiment is included in at least one embodiment. Thus, the quoted phrases, or variations thereof, as recited throughout this disclosure are not necessarily all referring to the same embodiment.

Similarly, it should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim in this or any application claiming priority to this application require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. § 112 Para. 6. It will be apparent to those having skill in the art that changes may be made to the details of the above-described embodiments without departing from the underlying principles of the disclosure.

While specific embodiments and applications of the present disclosure have been illustrated and described, it is to be understood that the disclosure is not limited to the precise configuration and components disclosed herein. Moreover, the present disclosure further contemplates methods of use and/or manufacture of any forearm sling described by this disclosure, which can include but is not limited to providing, installing, attaching, fitting, fabricating and/or configuring any portion of any forearm sling or accessory therefore as described anywhere in this disclosure. Various modifications, changes, and variations which will be apparent to those skilled in the art may be made in the arrangement, operation, and details of the methods and systems of the present disclosure disclosed herein without departing from the spirit and scope of the disclosure.

What is claimed is:

1. A method for displaying sentiment of a user communication, comprising:
receiving a communication string;
providing the communication to a sentiment model configured to output a sequence of sentiment scores;
receiving, from the sentiment model, the sequence of sentiment scores; and
generating, based on the final sentiment scores, a sentiment visualization for the text comment.

2. A computing device, comprising:
a processor; and
a memory including computer readable instructions, which, when executed by the processor, cause the computing device to perform a method for displaying sentiment of a user communication, the method comprising:
receiving a communication content;
providing the content to a sentiment model configured to output a sequence of sentiment scores;
receiving, from the sentiment model, the sequence of sentiment scores;
determining, final sentiment scores related to the communication; and
generating, based on the final sentiment scores, a sentiment visualization for the communication.
